(19) United States
(12) Patent Application Publication
(10) Pub. No.: US 2025/0253528 A1
(43) Pub. Date: Aug. 7, 2025

(54) BEAM FORMING USING AN ANTENNA ARRAY COMPRISING DUAL-POLARIZED ELEMENTS

(71) Applicant: Telefonaktiebolaget LM Ericsson (publ), Stockholm (SE)

(72) Inventors: Maksym GIRNYK, Solna (SE); Sven PETERSSON, Sävedalen (SE)

(73) Assignee: Telefonaktiebolaget LM Ericsson (publ), Stockholm (SE)

(21) Appl. No.: 18/851,173

(22) PCT Filed: Mar. 28, 2022
(86) PCT No.: PCT/EP2022/058148

§ 371 Date: Sep. 26, 2024

(51) Int. Cl. H01Q 3/36; H01Q 15/24

(52) U.S. Cl. CPC H01Q 3/36; H01Q 15/24

(57) ABSTRACT

There is provided mechanisms for beam forming using an antenna array comprising N>1 dual-polarized elements. Each dual-polarized element comprises a first element having a first polarization A and a second element having a second polarization B. Each first and second element has an individually controllable phase per polarization. A method comprises generating a dual-polarized beam by applying a first beamformer W_{A} and a second beamformer W_{B} to individually control the phase of the dual-polarized elements. The first beamformer W_{A} is formed from a first base beamformer W^{b}_{A} of the first polarization by an additional individual phase having been added to the first base beamformer W^{b}_{A} for each element of the first polarization A. The second beamformer W_{B} is formed from a second base beamformer W^{b}_{B} of the second polarization B by an additional individual phase having been added to the second base beamformer W^{b}_{B} for each element of the second polarization B.

### TECHNICAL FIELD

Embodiments presented herein relate to a method, a radio transceiver device, a computer program, and a computer program product for beam forming using an antenna array comprising dual-polarized elements.

### BACKGROUND

Large antenna arrays are known to increase throughput and robustness of wireless transmission. With the use of active antenna systems (AASs) the transmitted energy can be shaped into spatial radiation patterns, or (directional) beams. Accordingly, transmission can be steered towards a specific intended recipient, such as a user equipment (UE) in the downlink or an access network node in the uplink. The received signal power at the recipient can thereby be increased, thereby in turn improving throughput, data rates, etc. The gains achievable by such beamforming are promising and seem to be of great importance to achieve the goals of future radio networks.

At the same time, apart from creating (narrow) recipient-specific beams, the access network node should be capable of also creating (wide) region-specific beams to cover a certain angular sector, region, or cell, with a desired level of radiation. The need for AASs enabled to generate such wide beam patterns, as opposed to narrow beam patterns, arises in scenarios with higher rank transmission (e.g. 3-4 layers), where the potential loss in the gain due to beam widening may not be critical. At the same time, usage of wide beams may offer the increased probability of the higher transmission rank selection. The use of wide beams is also preferable in high mobility scenarios for more robust selection of the precoding at the access network nodes.

In some examples, the spatial radiation patterns are defined by codebooks constructed using Discrete Fourier Transform (DFT) vectors. This enables beamforming to be performed in a fixed set of angular directions. A beam defined by DFT vectors, by its nature, is characterized with full power utilization due to radiation with all the available power from every element in an antenna array. Such beamforming has a fixed radiation pattern, whose half-power beamwidth (HPBW) is determined by the parameters of the antenna array (number of elements, element spacing, HPBW of the radiation pattern of an element). The produced spatial radiation pattern is, however, narrow, and it gets narrower with the direct aperture increase. For example, an array of 8 omnidirectional elements with a nearest-neighbor spacing of 0.55 wavelengths, excited with a DFT vector will yield a radiation pattern with HPBW of only 12 degrees. Some existing approaches to address this issue will be summarized next.

According to a first example, a separate wide-beam antenna is used for transmission of broadcast data. A drawback with this approach is that it requires additional hardware.

According to a second example, broadcast data is transmitted using antenna array with a single element, or using a sub-array, of the antenna array. This element or sub-array will generate a wider beam than the full array of the antenna. A drawback of this approach is that only one, or a few, power amplifiers (PAs) in the antenna array is/are utilized, which thus wastes power resources (in the sense that power resources are under-utilized). Hence this approach will suffer from producing a low power output.

According to a third example, amplitude tapering is used for optimizing the amplitude of excitation weights (by reducing the gain for some of the elements, and/or even muting some elements) to broaden the spatial radiation pattern of the antenna array. Due to smaller amplitudes of the weights, this approach yields poor utilization of the power amplifier resources.

According to a fourth example, phase-only tapering is used over all elements of the antenna array to widen the beam. One drawback with this approach is that it is in many cases not possible to synthesize the desired beam shape (e.g., a complete spatially flat array factor). Moreover, spatial radiation patterns designed using this class of methods typically exhibit a non-negligible level of ripple.

According to a fifth example, broadcast data is transmitted sequentially in different directions using narrow beams. A drawback of this approach is that this takes longer time, and consumes more resource elements, than transmitting broadcast data simultaneously in all directions in a wide beam.

Hence, there is still a need for an improved techniques for generating spatial radiation patterns of different shapes.

### SUMMARY

An object of embodiments herein is to address the above issues.

According to a first aspect there is presented a method for beam forming using an antenna array comprising N>1 dual-polarized elements. Each dual-polarized element comprises a first element having a first polarization A and a second element having a second polarization B. Each first and second element has an individually controllable phase per polarization. The method comprises generating a dual-polarized beam by applying a first beamformer w_{A} and a second beamformer w_{B} to individually control the phase of the dual-polarized elements. The first beamformer w_{A} is formed from a first base beamformer w_{A}^{b} of the first polarization A by an additional individual phase having been added to the first base beamformer w_{A}^{b} for each element of the first polarization A. The second beamformer w_{B} is formed from a second base beamformer w_{B}^{b} of the second polarization B by an additional individual phase having been added to the second base beamformer w_{B}^{b} for each element of the second polarization B.

According to a second aspect there is presented a radio transceiver device (1200) for beam forming using an antenna array comprising N>1 dual-polarized elements. Each dual-polarized element comprises a first element having a first polarization A and a second element having a second polarization B. Each first and second element has an individually controllable phase per polarization. The radio transceiver device comprises processing circuitry. The processing circuitry is configured to cause the radio transceiver device to generate a dual-polarized beam by applying a first beamformer w_{A} and a second beamformer w_{B} to individually control the phase of the dual-polarized elements. The first beamformer w_{A} is formed from a first base beamformer w_{A}^{b} of the first polarization A by an additional individual phase having been added to the first base beamformer w_{A}^{b} for each element of the first polarization A. The second beamformer w_{B} is formed from a second base beamformer w_{B}^{b} of the second polarization B by an additional individual phase having been added to the second base beamformer w_{B}^{b} for each element of the second polarization B.

According to a third aspect there is presented a radio transceiver device for beam forming using an antenna array comprising N>1 dual-polarized elements. Each dual-polarized element comprises a first element having a first polarization A and a second element having a second polarization B. Each first and second element has an individually controllable phase per polarization. The radio transceiver device comprises a generate module configured to generate a dual-polarized beam by applying a first beamformer w_{A} and a second beamformer w_{B} to individually control the phase of the dual-polarized elements. The first beamformer w_{A} is formed from a first base beamformer w_{A}^{b} of the first polarization A by an additional individual phase having been added to the first base beamformer w_{A}^{b} for each element of the first polarization A. The second beamformer w_{B} is formed from a second base beamformer w_{B}^{b} of the second polarization B by an additional individual phase having been added to the second base beamformer w_{B}^{b} for each element of the second polarization B.

According to a fourth aspect there is presented a computer program for for beam forming using an antenna array comprising N>1 dual-polarized elements, the computer program comprising computer program code which, when run on a radio transceiver device, causes the radio transceiver device to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects enable dual-polarized beams with spatial radiation patterns of different shapes to be generated.

Advantageously, these aspects enable broad beam patterns to be generated with phase-only excitation weights.

Advantageously, these aspects do not suffer from the issues noted above.

Advantageously, these aspects are suitable for synthesizing any desired beam shape.

Advantageously, these aspects result in spatial beam patterns with negligible levels of ripple.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 shows the array factor for a spatial radiation pattern obtained according to according to an example;

FIG. 2 is a block diagram of a communication module according to embodiments;

FIG. 3 is a flowchart of methods according to embodiments;

FIG. 4 shows the array factor for a spatial radiation pattern obtained according to an embodiment;

FIG. 5 compares the performance of herein disclosed embodiments to an example;

FIG. 6 shows optimized spatial radiation patterns according to an embodiment;

FIG. 7 shows optimized spatial radiation patterns according to an example;

FIG. 8 shows the broadener function for different values of c as a function of element in an antenna array according to an embodiment;

FIG. 9 shows the total array factor as function of the radiation angle for different values of c according to an embodiment;

FIG. 10 shows the broadener function for different values of p as a function of element in an antenna array according to an embodiment;

FIG. 11 shows the total array factor as function of the radiation angle for different values of p according to an embodiment;

FIG. 12 is a schematic diagram showing functional units of a radio transceiver device according to an embodiment;

FIG. 13 is a schematic diagram showing functional modules of a radio transceiver device according to an embodiment;

FIG. 14 is a block diagram of an access node;

FIG. 15 is a block diagram of a user equipment; and

FIG. 16 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

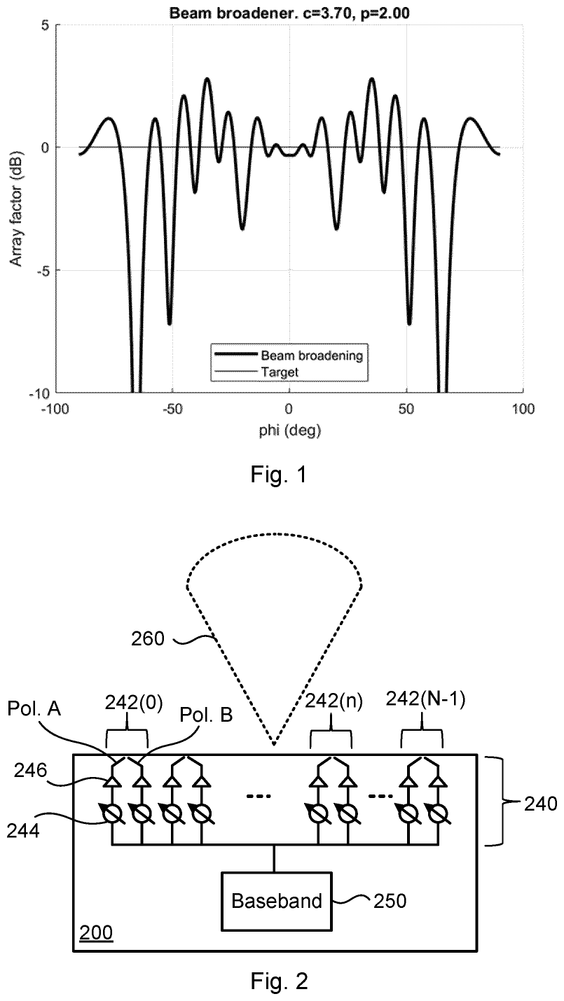

Consider the task of synthesizing a beam with flat spatially array factor (i.e., the spatial radiation pattern for the antenna array being an upscaled version of the spatial radiation pattern of one of its elements). FIG. 1 shows the array factor obtained according to methods disclosed in Sergeev, Victor, et al. “Enhanced precoding design with adaptive beam width for 5G new radio systems”, in Proc. IEEE 86th Vehicular Technology Conference (VTC-Fall), 2017 for an element spacing of 0.55λ, where λ is the wavelength. A DFT based base beamformer is used to yield a nominal spatial radiation pattern. A broadener function is then applied to broaden the nominal spatial radiation pattern. The obtained beamformer is based on using phase-shifts only, thereby providing full power utilization of the antenna array. This solution is a single-polarized beamformer (SPBF), and hence has intrinsic limitations of how broad the resulting spatial radiation pattern can be made. From FIG. 1 can further be observed that there is a deep null near 65°, and furthermore, there is a significant level of ripple in the array factor. The null appears due to the symmetry in the broadened beamformer and its location is determined by the pointing direction of the base beamformer. The embodiments disclosed herein relate to techniques for beam forming using an antenna array comprising N>1 dual-polarized elements that address these shortcomings.

According to at least some of the herein disclosed embodiments, a dual-polarized reference radiation pattern is broadened by means of individual phase shifts being applied to base beamformers in each of two polarizations. A broadened spatial beam pattern can thus be obtained from base beamformers with phase-only excitation weights. The herein disclosed embodiments can be used to remove inherent nulls and reduce the spatial ripple of the array factor of the method in the aforementioned article “Enhanced precoding design with adaptive beam width for 5G new radio systems”.

FIG. 2 illustrates a communication module 200 according to an embodiment. The communication module 200 comprises a baseband module 250 and an antenna array 240. The antenna array 240 comprises N>1 dual-polarized elements 242(0), . . . , 242(n), . . . 242(N−1). Each dual-polarized element 242(n) comprises a first element having a first polarization A and a second element having a second polarization B. Each first and second element has a phase being individually controlled by a phase shifter 244 and a gain being individually controlled by an amplifier 246. This implies that the antenna array 240 is using analog beamforming. Although the phase shifters 244 and the amplifiers 246 have been illustrated as separated from the baseband module 250, the phase shifters 244 and the amplifiers 246 can be implemented in the baseband module 250.

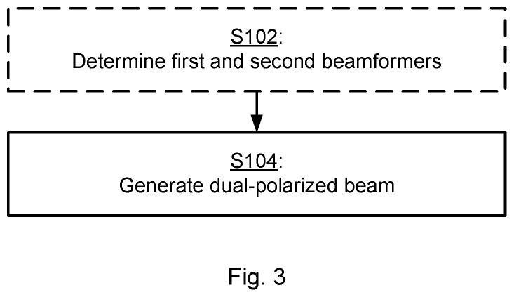

FIG. 3 is a flowchart illustrating embodiments of methods for beam forming using an antenna array 240 as described with reference to FIG. 2. The methods are performed by a radio transceiver device 1200, 1300. The methods are advantageously provided as computer programs.

S104: A dual-polarized beam 260 is generated by a first beamformer w_{A} and a second beamformer w_{B} being applied to individually control the phase of the dual-polarized elements 242(0):242(N−1).

The first beamformer w_{A} is formed from a first base beamformer w_{A}^{b} of a first polarization A by an additional individual phase having been added to the first base beamformer w_{A}^{b} for each element of the first polarization A. The second beamformer w_{B} is formed from a second base beamformer w_{B}^{b} of a second polarization B by an additional individual phase having been added to the second base beamformer w_{B}^{b} for each element of the second polarization B. In this respect, since the first base beamformer w_{A}^{b} and the second base beamformer w_{B}^{b} already impose that a phase shift is applied to the elements and hence, the term additional phase is here used to distinguish this phase shift from the phase shift caused by the first base beamformer w_{A}^{b} and the second base beamformer w_{B}^{b}.

Embodiments relating to further details of beam forming using an antenna array 240 comprising N>1 dual-polarized elements 242(0):242(N−1) as performed by the radio transceiver device will now be disclosed.

In some aspects, the first beamformer w_{A} and the second beamformer w_{B} are determined by the radio transceiver device, or another entity from which a signal that is to be transmitted by the radio transceiver device is provided. Hence, in some embodiments, the method comprises (optional) step S102 to be performed: S102: The first beamformer w_{A} is determined from the first base beamformer w_{A}^{b} of the first polarization A by adding the additional individual phase to the first base beamformer w_{A}^{b} for each element of the first polarization A. The second beamformer w_{B} is determined from the second base beamformer w_{B}^{b} of the second polarization B by adding the additional individual phase to the second base beamformer w_{B}^{b} for each element of the second polarization B.

Aspects of the base beamformers w_{A}^{b}, w_{B}^{b} will be disclosed next.

In some examples, the first base beamformer w_{A}^{b} and the second base beamformer w_{B}^{b} are not identical to each other. That is, in some examples, the second base beamformer w_{B}^{b} is different from the first base beamformer w_{A}^{b}.

There could be different examples of base beamformers w_{A}^{b}, w_{B}^{b}. In some examples, each of the first base beamformer w_{A}^{b} and the second base beamformer w_{B}^{b} is selected from a set of DFT base beam vectors.

Aspects of using a beam offset will be disclosed next.

In general terms, when the base beamformers w_{A}^{b}, w_{B}^{b} result in symmetric spatial radiation patterns with respect to a given pointing direction, the symmetry of the base beamformers w_{A}^{b}, w_{B}^{b} leads to the fact that the resulting beam (in one polarization) has a null at pointing angle

$${ϕ}_{null} = arcsin ( \frac{1}{2 {d}_{λ}} ) .$$

In this respect, A DFT base beam vector creates a beam with many nulls. By impacting the beam broadening effect (for example using a broadener function) most of these nulls can be removed, or at least made significantly less deep. But one of all these nulls cannot be removed if the beam broadening is performed with symmetrical phase. The direction of this null is given by ϕₙᵤₗₗ. The reason is that each pair, around the antenna array center, of elements in the antenna array cancel each other, thus creating a null. For beam broadening with symmetric phase they will still cancel each other. For an element spacing of d_{λ}=0.5 wavelengths, the null appears at ±90°, however this angle decreases with increasing d_{λ}.

With an aim to counter-act undesired nulls (for example as appearing in FIG. 1) a beam offset Δ might therefore be added for each per-polarization base beamformer. Hence, in some embodiments, a beam offset Δ or Δ_{A}, Δ_{B} is applied to at least one of the first beamformer w_{A} and the second beamformer w_{B}. Here, Δ_{A} denotes the beam offset applied to the first beamformer w_{A} and Δ_{B} denotes the beam offset applied to the second beamformer w_{B}. In this respect, when the base beamformers are defined by a (respective) set of DFT base beam vectors, then the beam offset might represent a DFT beam index.

There could be different ways in which the beam offset, or beam offsets, is/are applied. In some aspects, the beam offset, or beam offsets is/are added to one or both of the base beamformers. In particular, in some embodiments, the beam offset Δ or Δ_{A}, Δ_{B} is applied to the at least one of the first beamformer w_{A} and the second beamformer w_{B} by being applied to at least one of the base beamformers before the first beamformer w_{A} and the second beamformer w_{B} are formed from the base beamformers. In further detail, the beam offset (for each beamformer) might be applied by applying a phase slope. According to an example, a phase slope δ is applied to a boresight beam;

$${[ 1 , 1 , \text{…} , 1 ]}^{T} \to {[ 1 , {e}^{- j δ} , … , {e}^{- j ( N - 1 ) δ} ]}^{T} = {[ 1 , {e}^{- 2 j π {d}_{λ} sin {ϕ}_{0}} , … , {e}^{- 2 j π ( N - 1 ) {d}_{λ} sin {ϕ}_{0}} ]}^{T}$$

Here, ϕ₀ is the pointing beam direction shift with respect to the boresight direction (i.e., ϕ₀=0 in the boresight direction). In case the beam offset Δ represents a DFT beam index: Δ=0 yields ϕ₀=0 (boresight beam), Δ=1 yields ϕ₀=pointing direction of DFT beam 1, etc. However, it is here noted that Δ does not have to take an integer value. The phase slope δ is connected to beam offset Δ as

$$δ = 2 π \frac{Δ}{N} .$$

In general terms, the beam offset Δ is connected to the pointing direction of the base beamformers (relative a boresight pointing direction of the antenna array 240) via

$${ϕ}_{0} = arcsin ( \frac{Δ}{N {d}_{λ}} ) .$$

In this respect, in some embodiments, one of the base beamformers has a pointing direction ϕ₀ relative the boresight pointing direction of the antenna array 240, and the beam offset Δ is related to this pointing direction ϕ₀ via the above expression.

The beam offset Δ determines the base beamformers w_{A}^{b} and w_{B}^{b}. For instance, in the case of DFT beams, the base weights for a given polarization are given by

$${w}^{b} = {[ 1 , {e}^{- 2 j π {d}_{λ} sin {ϕ}_{0 ,}} , … , {e}^{- 2 j π ( N - 1 ) {d}_{λ} sin {ϕ}_{0}} ]}^{T} .$$

This enables nulls in one polarization to be compensated by with peaks (or at least a gain significantly larger than zero) in the other polarization, and by this improve the beam shape (in terms of flatness and reduction, or even absence, of ripple).

The array factor, in terms of total power radiation, is given by

$$G ( ϕ , θ ) = {\vert {w}_{A}^{T} a ( ϕ , θ ) \vert}^{2} + {\vert {w}_{B}^{T} a ( ϕ , θ ) \vert}^{2} ,$$

where a(ϕ, θ) is the steering vector of the antenna array. Assuming, without loss of generality, a horizontal antenna array, the steering vector is given by

$$a ( ϕ , θ ) = {[ 1 , {e}^{2 j π {d}_{λ} sin ϕ sin θ} , … , {e}^{2 j π ( N - 1 ) {d}_{λ} sin ϕ sin θ} ]}^{T} ,$$

where d_{λ} is the nearest-neighbor element spacing, as measured in terms of wavelengths, of the antenna array.

Aspects of using broadener functions will be disclosed next.

In general terms, for the n:th element in the antenna array of N elements, a broadener function can be expressed as ƒₙ(p, c), where (p, c) are broadener parameters that impact the beam broadening effect.

The broadener function is applied to the base beamformers in the two polarizations. Hence, there are two broadener functions; ƒ_{A,n}(p_{A}, c_{A}) and ƒ_{B,n}(p_{B}, c_{B}), one per polarization, with respective broadener parameters (p_{A}, c_{A}, p_{B}, c_{B}). In particular, in some embodiments, the additional individual phase having been added to the first beamformer w_{A} by a first broadener function ƒ_{A,n}(p_{A}, c_{A}) being applied to the first base beamformer w_{A}^{b}, and the additional individual phase having been added to the second beamformer w_{B} by a second broadener function ƒ_{B,n}(p_{B}, c_{B}) being applied to the second base beamformer w_{B}^{b}, where p_{A}, c_{A}, p_{B}, c_{B} are broadener parameters that take real-valued positive numbers.

Then, the first beamformer w_{A} and the second beamformer w_{B} might be given by:

$${w}_{A} = {w}_{A}^{b} ⊙ {[ {e}^{j {f}_{A , o} ( {p}_{A} , {c}_{A} )} , {e}^{j {f}_{A , 1} ( {p}_{A} , {c}_{A} )} , … , {e}^{j {f}_{A , N - 1} ( {p}_{A} , {c}_{A} )} ]}^{T} , and$$

$${w}_{B} = {w}_{B}^{b} ⊙ {[ {e}^{j {f}_{B , o} ( {p}_{B} , {c}_{B} )} , {e}^{j {f}_{B , 1} ( {p}_{B} , {c}_{B} )} , … , {e}^{j {f}_{B , N - 1} ( {p}_{B} , {c}_{B} )} ]}^{T} ,$$

where ⊙ denotes element-wise multiplication, and where 0≤n≤N−1 is the n:th dual-polarized element in the antenna array 240.

Consider now any of the polarizations (i.e., w=w_{A} or w=w_{A}, etc.). Then:

$$w = {w}^{b} ⊙ {[ {e}^{j {f}_{o} ( p , c )} , {e}^{j {f}_{1} ( p , c )} , … , {e}^{j {f}_{N - 1} ( p , c )} ]}^{T}$$

Returning briefly to the beam offsets, and taking DFT base beam vectors as an example, it is noted that:

$${[ 1 , {e}^{- 2 j π {d}_{λ} sin {ϕ}_{0}} , … , {e}^{- 2 j π ( N - 1 ) {d}_{λ} sin {ϕ}_{0}} ]}^{T} = {[ 1 , {e}^{- j δ} , … , {e}^{- j ( N - 1 ) δ} ]}^{T} = {[ 1 , {e}^{- \frac{2 j π Δ}{N}} , … , {e}^{- \frac{2 j ( N - 1 ) Δ}{N}} ]}^{T}$$

Hence:

$$w = [ {\begin{matrix}1 , & {e}^{- \frac{2 j π Δ}{N}} , & … , & {{e}^{- \frac{2 j ( N - 1 ) Δ}{N}} ]}^{T} ⊙\end{matrix} [ {e}^{{jf}_{0} ( p , c )} , {e}^{{jf}_{1} ( p , c )} , … , {e}^{{jf}_{N - 1} ( p , c )} ]}^{T} = {[ \begin{matrix}{e}^{{jf}_{0} ( p , c )} , & {e}^{{jf}_{1} ( p , c ) - \frac{2 j π Δ}{N}} , & … , & {e}^{{jf}_{N - 1} ( p , c ) - \frac{2 j ( N - 1 ) Δ}{N}}\end{matrix} ]}^{T}$$

This expression is valid for both w_{A} and w_{B} (with respective base beamformers w_{A}^{b}, w_{B}^{b}, respective broadener functions ƒ_{A,n}(p_{A}, c_{A}), ƒ_{B,n}(p_{B}, c_{B}) and respective beam offsets Δ_{A}, Δ_{B}).

In some aspects, there are different broadener functions per polarization. Hence, in some embodiments, the second broadener function ƒ_{B,n} (p_{B}, c_{B}) is different from the first broadener function ƒ_{A,n}(p_{A}, c_{A}). There could be different ways to select the broadener functions. In general terms, each broadener function should be symmetric (or nearly-symmetric), to not change the pointing direction of the base beamformer, and have a progressive phase increase to broaden the beam shape of the base beamformer.

According to a first example the first broadener function ƒ_{A,n}(p_{A}, c_{A}) and the second broadener function ƒ_{B,n}(p_{B}, c_{B}) are defined as:

$${f}_{A , n} ( {p}_{B} , {c}_{B} ) = {f}_{B , n} ( {p}_{B} , {c}_{B} ) = {f}_{n} ( p , c ) = c {\vert [ \frac{2 n - N + 1}{2 ( N - 1 )} ] \vert}^{p} ,$$

where p, c are positive real-valued numbers.

According to a second example the first broadener function ƒ_{A,n}(p_{A}, c_{A}) and the second broadener function ƒ_{B,n}(p_{B}, c_{B}) are defined as:

$${f}_{A , n} ( {p}_{B} , {c}_{B} ) = {f}_{B , n} ( {p}_{B} , {c}_{B} ) = {f}_{n} ( p , c ) = c {\vert 1 - cos [ \frac{π ( 2 n - N + 1 )}{2 ( N - 1 )} ] \vert}^{p} ,$$

where p, c are positive real-valued numbers. It is here noted that, for both examples, for the broadener functions to be different per polarization, the values of p, and/or c are selected differently for the different polarizations A, B. That is, p_{B}≠p_{B} and/or c_{B}≠c_{B}. In yet further examples, the first broadener function ƒ_{A,n}(p_{A}, c_{A}) and the second broadener function ƒ_{B,n}(p_{B}, c_{B}) are not formed from one and the same base broadener function ƒₙ (p, c).

The broadener functions of both the first example and the second example fulfil the desired properties.

To illustrate this, consider an antenna array being a uniform linear array (ULA) of size N=10 with two ports; one per polarization, and where both per-polarization ports are excited with weights:

$$w = {w}^{b} ⊙ {[ {e}^{j {f}_{0} ( p , c )} , {e}^{j {f}_{1} ( p , c )} , … , {e}^{j {f}_{N - 1} ( p , c )} ]}^{T} ,$$

where w^{b} is a base beamformer representing a DFT beam.

In some embodiments, the first broadener function ƒ_{A,n}(p_{A}, c_{A}) and the second broadener function ƒ_{B,n}(p_{B}, c_{B}) are matrix-valued. In further detail, the proposed dual-polarized beam can be created as follows:

$$W = [ \begin{matrix}{F}_{A} ( p , c ) & 0 \\ 0 & {F}_{B} ( p , c )\end{matrix} ] {W}^{b}$$

where F_{A}(p, c)=F_{B}(p, c)=diag(e^{jf}^{₀}^{(p,c)}, e^{jf}^{₁}^{(p,c)}, . . . , e^{jf}^{_{N-1}}^{(p,c)}) are broadener matrices and

$${W}^{b} = [ \begin{matrix}{w}_{a}^{b} & 0 \\ 0 & {w}_{B}^{b}\end{matrix} ]$$

is a matrix consisting of base beamformers (again, F_{A} (p, c) and F_{B}(p, c) do not have to be the same. In this way, a beam orthogonal to the above beam W can be constructed as:

$${W}^{⊥} = [ \begin{matrix}{F}_{A}^{⊥} ( p , c ) & 0 \\ 0 & {F}_{B}^{⊥} ( p , c )\end{matrix} ] {W}^{b ⊥} ,$$

where F_{A}^{⊥}(p,c)=E_{N}F*_{B}(p,c)E_{N}, F_{B}^{⊥}(p,c)=E_{N}F*_{A}(p,c)E_{N} and

$${W}^{b ⊥} = [ \begin{matrix}- {{E}_{N} ( {w}_{B}^{b} )}^{*} & 0 \\ 0 & {{E}_{N} ( {w}_{A}^{b} )}^{*}\end{matrix} ] ,$$

where E_{N} is an exchange matrix of size N, having ones on the secondary diagonal. That is:

$${E}_{N} = [ \begin{matrix}0 & … & 1 \\ ⋮ & ⋰ & ⋮ \\ 1 & … & 0\end{matrix} ] .$$

It is noted that the disclosed sequence of actions for generating the dual-polarized beam (e.g., selecting base beamformer(s), determining beam offset(s) incorporating the beam offset(s) in the base beamformer(s), determining broadener function(s), applying the broadener function(s) to the base beamformer(s) to get per-polarization weights to be applied to the phase shifters) represents a logical step-wise process of the synthesis of generating the dual-polarized beam. However, the actions do not have to be performed in the order disclosed. For instance, the beam offset(s) could be directly incorporated into the broadener function(s) or even the base beamformer(s), such that the base beamformer contribute to the broadness of the spatial radiation pattern of the determined beamformers with its own beamshape.

Further in this respect, it is noted that although the herein disclosed embodiments have been disclosed in terms of using base beamformers based on DFT beams, vectors, or codebooks, any suitable base beamformers can be used.

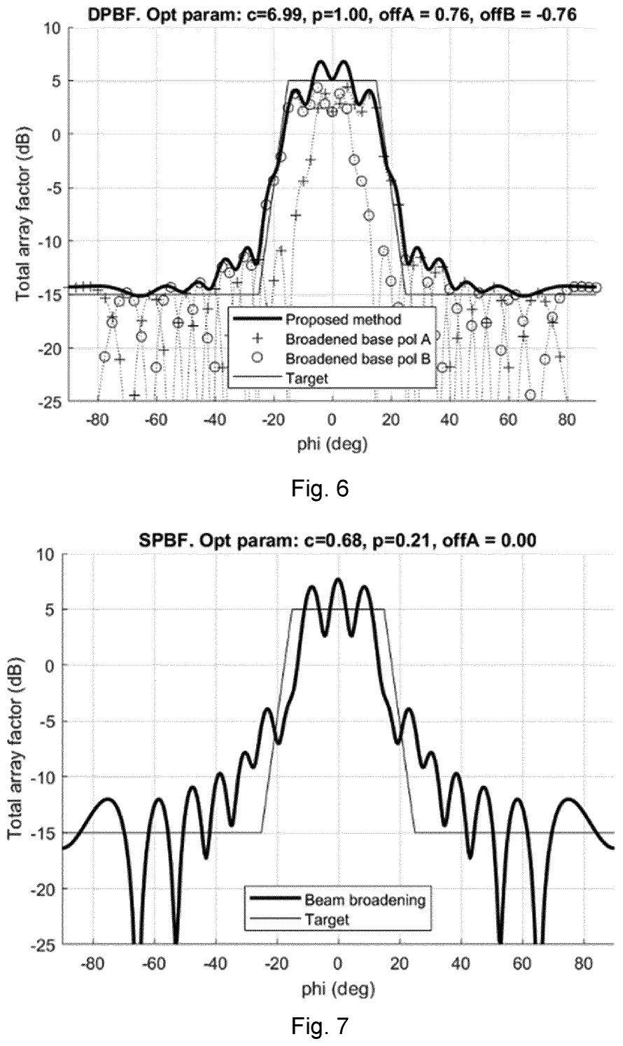

In some examples, the additional individual phase for each element of the first polarization A and the additional individual phase for each element of the second polarization B are determined according to a target function. The target function at least specifies Half Power Beam Width (HPBW) of a target antenna radiation pattern. Different examples of this will be disclosed below with reference to FIG. 6

In some embodiments, the broadener parameters p_{A}, c_{A}, p_{B}, c_{B} and the beam offset Δ or Δ_{A}, Δ_{B} are jointly optimized for the target function, e.g., to achieve a beam shape that is sufficiently close to the target function. The parameters (p_{A}, c_{A}, p_{B}, c_{B}, Δ_{A}, Δ_{B}) can be jointly optimized, e.g., by means of a simple grid search, a random search or other known non-convex optimization algorithms (e.g., simulated annealing, differential evolution, genetic algorithm, particle swarm optimization, threshold acceptance, great deluge algorithm, etc. or a combination thereof, e.g., the Godlike algorithm, see for example R. P. Oldenhuis, “Trajectory optimization for a mission to the solar bowshock and minor planets”, M.Sc. thesis, TU Delft, 2010). The input vector consists of the parameters (p_{A}, c_{A}, p_{B}, c_{B}, Δ_{A}, Δ_{B}), whereas the objective can be set as the variance of the spatial beam ripple, HPBW, etc. For this purpose, multi-objective algorithms could be used as well.

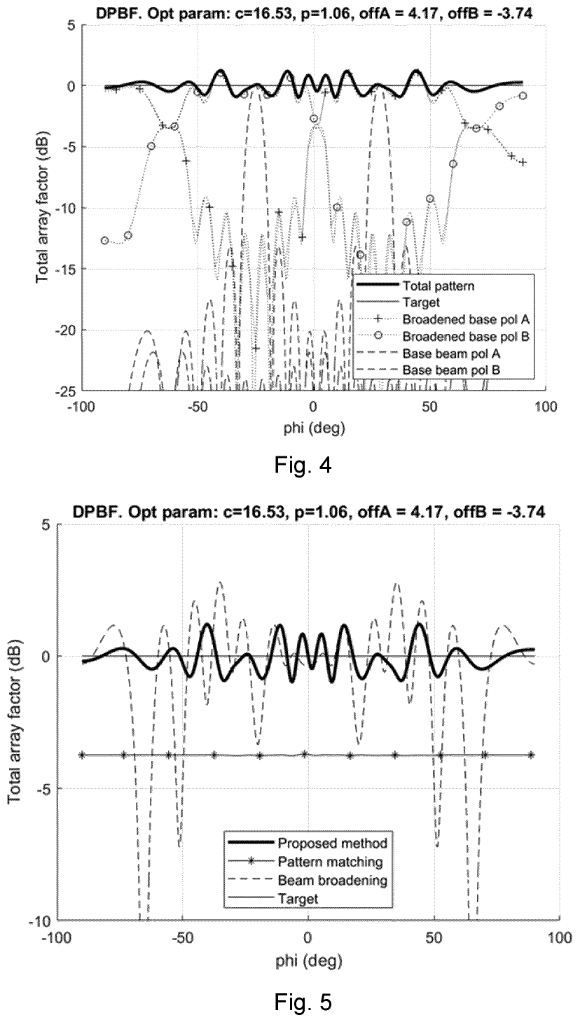

FIG. 4 shows the array factor for a ULA with N=16 elements having nearest-neighbor spacing of d_{λ}=0.55, obtained by the jointly optimized parameters (p_{A}, c_{A}, p_{B}, c_{B}, Δ_{A}, Δ_{B}) by means of the Godlike algorithm. In the figure, dotted lines with markers indicate the per-polarization beam shapes and solid lines with markers indicate the per-polarization base beams. For the results in this figure, a DFT beam vector pointing in the boresight direction excited with all phases equal was used as base beamformer, N=16, d_{λ}=0.55, c_{A}=c_{B}=16.53, p_{A}=p_{B}=1.06, Δ_{A}=4.17, and Δ_{B}=−3.74.

FIG. 5 compares the performance of the obtained dual-polarized beam versus that of the “pattern matching” approach disclosed in Qiao, Deli, Haifeng Qian, and Geoffrey Ye Li, “Broadbeam for massive MIMO systems”, IEEE Transactions on Signal Processing 64.9 (2016): 2365-2374. It can be seen from the figure that the proposed method, albeit having a certain amount of ripple, is much more power-efficient (about 4 dB gain) than the pattern-matching solution. In the figure is also shown a target beam with a flat array factor. It can be observed that the proposed method yields a dual-polarized beam whose spatial radiation pattern is quite close to the optimization target beam and has full power utilization, i.e., where all elements radiate at maximum power. The spatial radiation pattern of the dual-polarized beam obtained with the proposed method exhibits significantly lower ripple and does not have a deep null as does the broadening method of aforementioned article “Enhanced precoding design with adaptive beam width for 5G new radio systems”, which is the desired property for a cell-specific beam. Moreover, due to full power amplifier utilization, the radiation level is higher than that of the pattern matching method of the aforementioned article “Broadbeam for massive MIMO systems”.

As noted above the additional individual phase for each element of the first polarization A and the additional individual phase for each element of the second polarization B might be determined according to a target function. Further aspects of this will now be disclosed. In this respect, the herein disclosed embodiments can be used to determine beamformers that do not result in dual-polarized beams having a flat array factor. The herein disclosed embodiments can also be useful for general beam synthesis (i.e., determining beamformers for dual-polarized beams having a general desired spatial radiation pattern). To achieve this, as before, the first beamformer w_{A} is formed from a first base beamformer w_{A}^{b} of a first polarization A by an additional individual phase being added to the first base beamformer w_{A}^{b} for each element of the first polarization A, and the second beamformer wD is formed from a second base beamformer w_{B}^{b} of a second polarization B by an additional individual phase being added to the second base beamformer w_{B} for each element of the second polarization B. This can be achieved, for example, by applying a respective broadener function ƒ_{A,n}(p_{A}, c_{A}), ƒ_{B,n}(p_{B}, c_{B}) to a base beamformer w_{A}^{b}, w_{B}^{b} in each polarization A, B. The set of parameters (p_{A}, c_{A}, p_{B}, c_{B}, Δ_{A}, Δ_{B}) are then optimized for the given target (as defined by the desired spatial radiation pattern). The given target should capture the necessary requirements on broadness and discrimination outside of the main beam. For instance, FIG. 6 shows optimized spatial radiation patterns with a HPBW of 30° and a discrimination of −20 dB. The variance of the difference between the array factor and the target in logarithmic scale is used as the cost function for the optimization. For the results in this figure, a DFT beam vector pointing in the boresight direction excited with all phases equal was used as base beamformer, N=16, d_{Δ}=0.55, c_{A}=c_{B}=6.99, p_{A}=p_{B}=1.00, Δ_{A}=0.76, and Δ_{B}=−0.76. As a comparison, the result of using the single-polarization method in the aforementioned article “Enhanced precoding design with adaptive beam width for 5G new radio systems” with c_{A}=0.68, p_{A}=0.21, and Δ_{A}=0.00 are shown in FIG. 7. By comparing FIG. 6 to FIG. 7 it can be seen that the proposed method much better matches the target shape than the method of the aforementioned article “Enhanced precoding design with adaptive beam width for 5G new radio systems”. One reason for that is the additional degrees of freedom coming from using dual-polarized beamforming operations which enable a greater flexibility in the spatial radiation patterns.

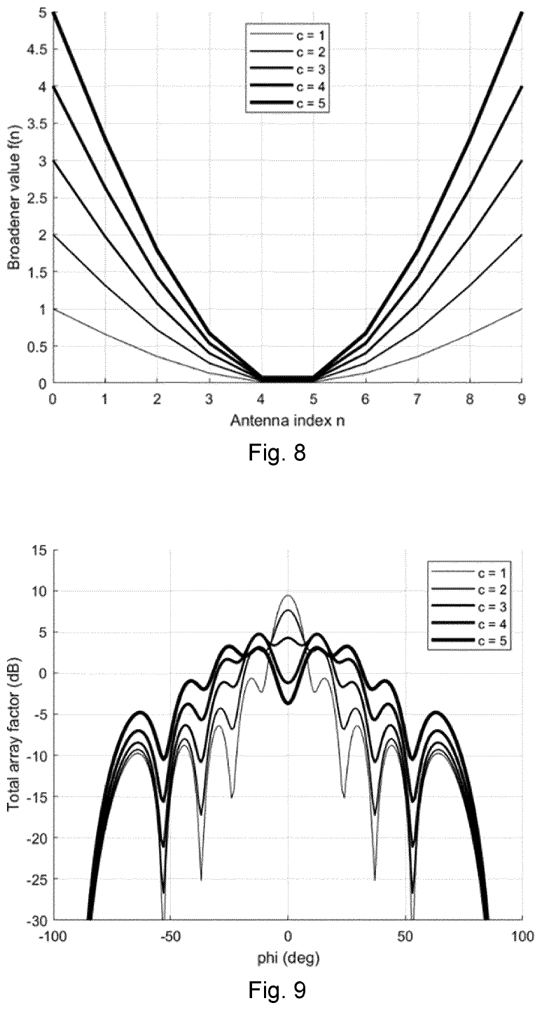

Further aspects relating to the impact of the broadener parameters (p_{A}, c_{A}, p_{B}, c_{B}) will be disclosed next. In this respect, the properties are the same regardless of polarization and it will henceforth be assumed that c_{A}=c_{B}=c and that p_{A}=p_{B}=p. FIG. 8 and FIG. 9 demonstrate the effect of changing the parameter c. In FIG. 8 is illustrated the same broadener function for different values of c as a function of element n in the antenna array. In FIG. 9 is illustrated the total array factor (in dB) as function of the radiation angle ϕ for different values of c. It can be seen that an increase in c leads to a sharper phase progression (see, FIG. 8) which results into a broader beam shape (see, FIG. 9).

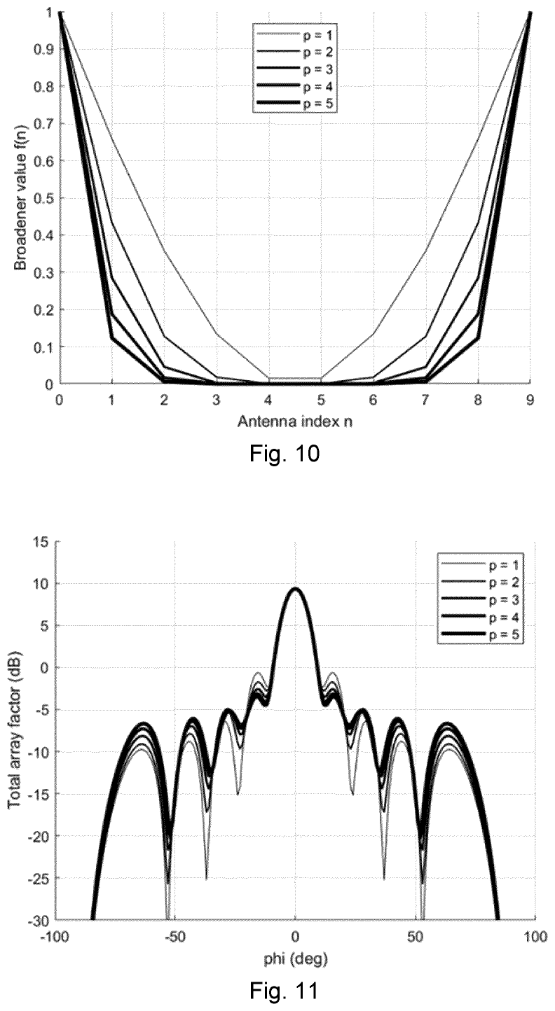

FIG. 10 and FIG. 11 demonstrate the effect of changing the parameter p. In FIG. 10 is illustrated the same broadener function for different values of p as a function of element n in the antenna array. In FIG. 11 is illustrated the total array factor (in dB) as function of the radiation angle ϕ for different values of p. It can be seen that as p increases, the flat-phase region in the middle of the antenna array gets broader. In turn, this leads to smoothened sidelobes of the array factor. Conversely, smaller values of p lead to sidelobe suppression.

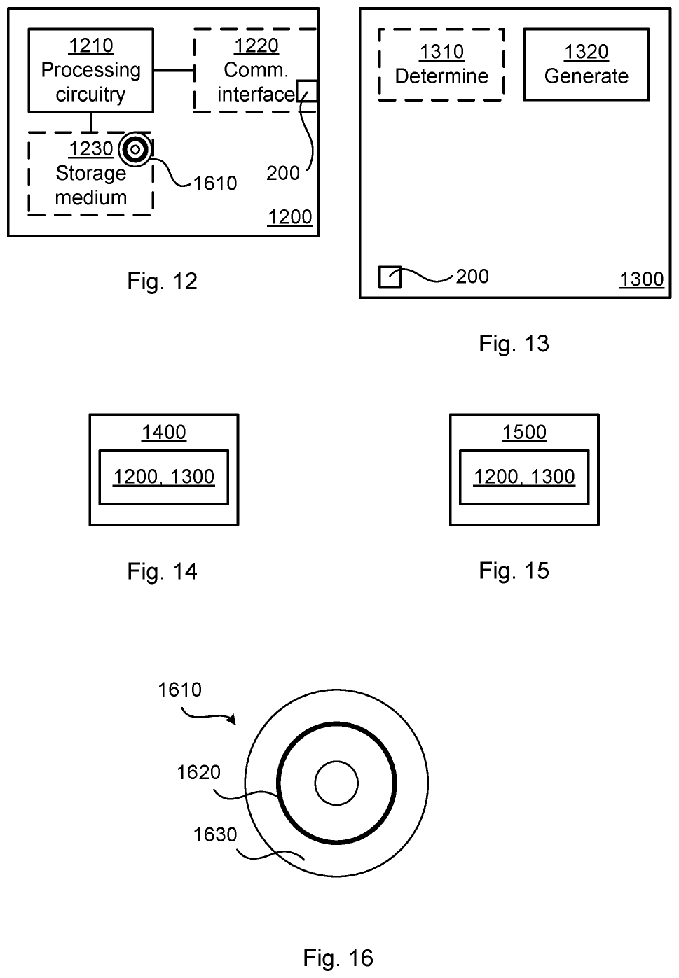

FIG. 12 schematically illustrates, in terms of a number of functional units, the components of a radio transceiver device 1200 according to an embodiment. Processing circuitry 1210 is provided using any combination of one or more of a suitable central processing unit (CPU), multiprocessor, microcontroller, digital signal processor (DSP), etc., capable of executing software instructions stored in a computer program product 1610 (as in FIG. 16), e.g. in the form of a storage medium 1230. The processing circuitry 1210 may further be provided as at least one application specific integrated circuit (ASIC), or field programmable gate array (FPGA).

Particularly, the processing circuitry 1210 is configured to cause the radio transceiver device 1200 to perform a set of operations, or steps, as disclosed above. For example, the storage medium 1230 may store the set of operations, and the processing circuitry 1210 may be configured to retrieve the set of operations from the storage medium 1230 to cause the radio transceiver device 1200 to perform the set of operations. The set of operations may be provided as a set of executable instructions.

Thus the processing circuitry 1210 is thereby arranged to execute methods as herein disclosed. The storage medium 1230 may also comprise persistent storage, which, for example, can be any single one or combination of magnetic memory, optical memory, solid state memory or even remotely mounted memory. The radio transceiver device 1200 may further comprise a communications interface 1220 at least configured for communications with another radio transceiver device 1200. The communication module 200 might be implemented in the communications interface 1220. As such the communications interface 1220 may comprise one or more transmitters and receivers, comprising analogue and digital components. The processing circuitry 1210 controls the general operation of the radio transceiver device 1200 e.g. by sending data and control signals to the communications interface 1220 and the storage medium 1230, by receiving data and reports from the communications interface 1220, and by retrieving data and instructions from the storage medium 1230. Other components, as well as the related functionality, of the radio transceiver device 1200 are omitted in order not to obscure the concepts presented herein.

FIG. 13 schematically illustrates, in terms of a number of functional modules, the components of a radio transceiver device 1300 according to an embodiment. The radio transceiver device 1300 of FIG. 13 comprises the communication module 200. The radio transceiver device 1300 of FIG. 13 further comprises a generate module 1320 configured to perform step S104. The radio transceiver device 1300 of FIG. 13 may further comprise a number of optional functional modules, such as a determine module 1310 configured to perform step S102. In general terms, each functional module 1310:1320 may in one embodiment be implemented only in hardware and in another embodiment with the help of software, i.e., the latter embodiment having computer program instructions stored on the storage medium 1230 which when run on the processing circuitry makes the radio transceiver device 1300 perform the corresponding steps mentioned above in conjunction with FIG. 13. It should also be mentioned that even though the modules correspond to parts of a computer program, they do not need to be separate modules therein, but the way in which they are implemented in software is dependent on the programming language used. Preferably, one or more or all functional modules 1310:1320 may be implemented by the processing circuitry 1210, possibly in cooperation with the communications interface 1220 and/or the storage medium 1230. The processing circuitry 1210 may thus be configured to from the storage medium 1230 fetch instructions as provided by a functional module 1310:1320 and to execute these instructions, thereby performing any steps as disclosed herein.

The radio transceiver device 1200, 1300 can be provided as integrated circuits, as standalone devices or as a part of a further device. For example, the radio transceiver device 1200, 1300 can be provided in an access network node or a user equipment. FIG. 14 illustrates an access network node 1400 comprising a radio transceiver device 1200, 1300 as herein disclosed. The access network node 1400 might be a radio base station, base transceiver station, NodeB (NB), evolved NodeB (eNB), gNB, a repeater, a backhaul node, an integrated access and backhaul node, a fixed wireless access node, or the like. FIG. 15 illustrates a user equipment 1500 comprising a radio transceiver device 1200, 1300 as herein disclosed. The user equipment 1500 can be a portable wireless device, mobile station, mobile phone, handset, wireless local loop phone, smartphone, laptop computer, tablet computer, wireless sensor, network equipped vehicle, gaming device, or the like. The radio transceiver device 1200, 1300 can be provided as an integral part of the further device. That is, the components of the radio transceiver device 1200, 1300 can be integrated with other components of the further device; some components of the further device and the radio transceiver device 1200, 1300 can be shared. For example, if the further device as such comprises a processor, this processor can be configured to perform the actions of the processing circuitry 1210 associated with the radio transceiver device 1200, 1300. Alternatively, the radio transceiver device 1200, 1300 can be provided as one or more separate units in the further device.

FIG. 16 shows one example of a computer program product 1610 comprising computer readable storage medium 1630. On this computer readable storage medium 1630, a computer program 1620 can be stored, which computer program 1620 can cause the processing circuitry 1210 and thereto operatively coupled entities and devices, such as the communications interface 1220 and the storage medium 1230, to execute methods according to embodiments described herein. The computer program 1620 and/or computer program product 1610 may thus provide means for performing any steps as herein disclosed.

In the example of FIG. 16, the computer program product 1610 is illustrated as an optical disc, such as a CD (compact disc) or a DVD (digital versatile disc) or a Blu-Ray disc. The computer program product 1610 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1620 is here schematically shown as a track on the depicted optical disk, the computer program 1620 can be stored in any way which is suitable for the computer program product 1610.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for beam forming using an antenna array comprising N>1 dual-polarized elements, each dual-polarized element comprising a first element having a first polarization A and a second element having a second polarization B, each first and second element having an individually controllable phase, the method comprising:
generating a dual-polarized beam by applying a first beamformer w_{A} and a second beamformer w_{B} to individually control the phase of the dual-polarized elements,
wherein the first beamformer w_{A} is formed from a first base beamformer w_{A}^{b} of the first polarization A by an additional individual phase having been added to the first base beamformer w_{A}^{b} for each element of the first polarization A, and the second beamformer w_{B} is formed from a second base beamformer w_{B}^{b} of the second polarization B by an additional individual phase having been added to the second base beamformer w_{B}^{b} for each element of the second polarization B.

2. The method of claim 1, wherein a beam offset Δ or Δ_{A}, Δ_{B} is applied to at least one of the first beamformer w_{A} and the second beamformer w_{B}.

3. The method of claim 2, wherein the beam offset Δ or Δ_{A}, Δ_{B} is applied to the at least one of the first beamformer w_{A} and the second beamformer w_{B} by being applied to at least one of the base beamformers before the first beamformer w_{A} and the second beamformer w_{B} are formed from the base beamformers.

4. The method of claim 2, wherein one of the base beamformers has a pointing direction ϕ₀ relative a boresight pointing direction of the antenna array, and wherein the beam offset Δ is related to said pointing direction ϕ₀ via:
$${ϕ}_{0} = arc sin ( \frac{Δ}{N {d}_{λ}} ) .$$

5. The method of claim 1, wherein the second base beamformer w_{B}^{b} is different from the first base beamformer w_{A}^{b}.

6. The method of claim 1, wherein each of the first base beamformer w_{A}^{b} and the second base beamformer w_{B}^{b} is selected from a set of Discrete Fourier Transform base beam vectors.

7. The method of claim 1, wherein the additional individual phase having been added to the first beamformer w_{A} by a first broadener function ƒ_{A,n} (p_{A}, c_{A}) being applied to the first base beamformer w_{A}^{b}, and wherein the additional individual phase having been added to the second beamformer w_{B} by a second broadener function ƒ_{B,n}(p_{B}, c_{B}) being applied to the second base beamformer w_{B}^{b}, where p_{A}, c_{A}, p_{B}, c^{B} are broadener parameters that take real-valued positive numbers.

8. The method of claim 7, wherein the first beamformer w_{A} and the second beamformer w_{B} are given by:
$${w}_{A} = {w}_{A}^{b} ⊙ {[ {e}^{j {f}_{A , o} ( {p}_{A} , {c}_{A} )} , {e}^{{jf}_{A , 1} ( {p}_{A} , {c}_{A} )} , … , {e}^{{jf}_{A , N - 1} ( {p}_{A} , {c}_{A} )} ]}^{T} , and$$
$${w}_{B} = {w}_{B}^{b} ⊙ {[ {e}^{j {f}_{B , o} ( {p}_{B} , {c}_{B} )} , {e}^{j {f}_{B , 1} ( {p}_{B} , {c}_{B} )} , … , {e}^{j {f}_{B , N - 1} ( {p}_{B} , {c}_{B} )} ]}^{T} ,$$
where ⊙ denotes element-wise multiplication, and where 0≤n≤N−1 is the n:th dual-polarized element in the antenna array.

9. The method of claim 7, wherein the second broadener function ƒ_{B,n}(p_{B}, c_{B}) is different from the first broadener function ƒ_{A,n}(p_{A}, c_{A}).

10. The method of claim 7, wherein the first broadener function ƒ_{A,n}(p_{A}, c_{A}) and the second broadener function ƒ_{B,n}(p_{B}, c_{B}) are matrix-valued.

11. The method of claim 7, wherein the first broadener function ƒ_{A,n}(p_{A}, c_{A}) and the second broadener function ƒ_{B,n}(p_{B}, c_{B}) are defined as:
$${f}_{A , n} ( {p}_{B} , {c}_{B} ) = {f}_{B , n} ( {p}_{B} , {c}_{B} ) = {f}_{n} ( p , c ) = c {\vert [ \frac{2 n - N + 1}{2 ( N - 1 )} ] \vert}^{p} ,$$
where p, c are positive real-valued numbers.

12. The method of claim 7, wherein the first broadener function ƒ_{A,n}(p_{A}, c_{A}) and the second broadener function ƒ_{B,n}(p_{B}, c_{B}) are defined as:
$${f}_{A , n} ( {p}_{B} , {c}_{B} ) = {f}_{B , n} ( {p}_{B} , {c}_{B} ) = {f}_{n} ( p , c ) = c {\vert 1 - cos [ \frac{π ( 2 n - N + 1 )}{2 ( N - 1 )} ] \vert}^{p} ,$$
where p, c are positive real-valued numbers.

13. The method of claim 1, wherein the additional individual phase for each element of the first polarization A and the additional individual phase for each element of the second polarization B are determined according to a target function, wherein the target function at least specifies Half Power Beam Width of a target antenna radiation pattern.

14. The method of claim 13, wherein
a beam offset Δ or Δ_{A},Δ_{B} is applied to at least one of the first beamformer w_{A} and the second beamformer w_{B},
the additional individual phase having been added to the first beamformer w_{A} by a first broadener function ƒ_{A,n}(p_{A}, c_{A}) being applied to the first base beamformer w_{A}^{b}, and wherein the additional individual phase having been added to the second beamformer w_{B} by a second broadener function ƒ_{B,n}(p_{B}, c_{B}) being applied to the second base beamformer w_{B}^{b}, where p_{A}, c_{A}, p_{B}, c_{B} are broadener parameters that take real-valued positive numbers, and
the broadener parameters p_{A}, c_{A}, p_{B}, c_{B} and the beam offset Δ or Δ_{A}, Δ_{B} are jointly optimized for the target function.

15. A radio transceiver device for beam forming using an antenna array comprising N>1 dual-polarized elements, each dual-polarized element comprising a first element having a first polarization A and a second element having a second polarization B, each first and second element having an individually controllable phase, the radio transceiver device comprising processing circuitry, the processing circuitry being configured to cause the radio transceiver device to:
generate a dual-polarized beam by applying a first beamformer w_{A} and a second beamformer w_{B} to individually control the phase of the dual-polarized elements,
wherein the first beamformer w_{A} is formed from a first base beamformer w_{A}^{b} of the first polarization A by an additional individual phase having been added to the first base beamformer w_{A}^{b} for each element of the first polarization A, and the second beamformer w_{B} is formed from a second base beamformer w_{B}^{b} of the second polarization B by an additional individual phase having been added to the second base beamformer w_{B}^{b} for each element of the second polarization B.

16. The radio transceiver device of claim 15, wherein a beam offset Δ or Δ_{A}, Δ_{B} is applied to at least one of the first beamformer w_{A} and the second beamformer w_{B}.

17. (canceled)

18. The radio transceiver device of claim 16, wherein one of the base beamformers has a pointing direction ϕ₀ relative a boresight pointing direction of the antenna array, and wherein the beam offset Δ is related to said pointing direction ϕ₀ via:
$${ϕ}_{0} = arc sin ( \frac{Δ}{N {d}_{λ}} ) .$$

19-20. (canceled)

21. The radio transceiver device of claim 15, wherein the additional individual phase having been added to the first beamformer w_{A} by a first broadener function ƒ_{A,n}(p_{A}, c_{A}) being applied to the first base beamformer w_{A}^{b}, and wherein the additional individual phase having been added to the second beamformer w_{B} by a second broadener function ƒ_{B,n}(p_{B}, c_{B}) being applied to the second base beamformer w_{B}^{b}, where p_{A}, c_{A}, p_{B}, c_{B} are broadener parameters that take real-valued positive numbers.

22. The radio transceiver device of claim 21, wherein the first beamformer w_{A} and the second beamformer w_{B} are given by:
$${w}_{A} = {w}_{A}^{b} ⊙ {[ {e}^{j {f}_{A , o} ( {p}_{A} , {c}_{A} )} , {e}^{{jf}_{A , 1} ( {p}_{A} , {c}_{A} )} , … , {e}^{{jf}_{A , N - 1} ( {p}_{A} , {c}_{A} )} ]}^{T} , and$$
$${w}_{B} = {w}_{B}^{b} ⊙ {[ {e}^{j {f}_{B , o} ( {p}_{B} , {c}_{B} )} , {e}^{j {f}_{B , 1} ( {p}_{B} , {c}_{B} )} , … , {e}^{j {f}_{B , N - 1} ( {p}_{B} , {c}_{B} )} ]}^{T} ,$$
where ⊙ denotes element-wise multiplication, and where 0≤n≤N−1 is the n:th dual-polarized element in the antenna array.

23-28. (canceled)

29. A computer program-product for beam forming using an antenna array comprising N>1 dual-polarized elements, each dual-polarized element comprising a first element having a first polarization A and a second element having a second polarization B, each first and second element having an individually controllable phase per polarization, the computer program product comprising a non-transitory computer readable medium storing instructions, when executed by processing circuitry of a radio transceiver device, causes the radio transceiver device to:
generate a dual-polarized beam by applying a first beamformer w_{A} and a second beamformer w_{B} to individually control the phase of the dual-polarized elements,
wherein the first beamformer w_{A} is formed from a first base beamformer w_{A}^{b} of the first polarization A by an additional individual phase having been added to the first base beamformer w_{A}^{b} for each element of the first polarization A, and the second beamformer w_{B} is formed from a second base beamformer w_{B}^{b} of the second polarization B by an additional individual phase having been added to the second base beamformer w_{B}^{b} for each element of the second polarization B.

30. (canceled)
